(19) United States
(12) Patent Application Publication
(10) Pub. No.: US 2024/0310841 A1
(43) Pub. Date: Sep. 19, 2024

(54) Remote Vehicle Operation with High Latency Communications

(71) Applicants: Allen Samuels, San Jose, CA (US); Gopal Solanki, San Jose, CA (US)

(72) Inventors: Allen Samuels, San Jose, CA (US); Gopal Solanki, San Jose, CA (US)

(21) Appl. No.: 18/550,290

(22) PCT Filed: Apr. 11, 2022
(86) PCT No.: PCT/US22/24176

§ 371 Date: Sep. 13, 2023

(51) Int. Cl. G05D 1/222; G05D 1/248; G05D 111/10; G05D 111/50

(52) U.S. Cl. CPC G05D 1/222; G05D 1/248; G05D 2111/10; G05D 2111/52; G05D 2111/54

(57) ABSTRACT

A system to remotely operate a vehicle in the presence of limited bandwidth and high latency is disclosed. A remote driver station calculates and transmits a trajectory to a vehicle. The vehicle relocalizes and then follows said trajectory. Images captured by cameras on the vehicle are processed and then compressed for transmission over the limited bandwidth connection to the remote driver. Other sensors on the vehicle collect information which is transmitted to the remote driver as well as aiding in the processing and compression of visual information.

### CROSS-REFERENCE TO RELATED APPLICATIONS

This application claims priority to provisional application No. 63/173,494 (EFS ID 42421162) dated 11 Apr. 2021 and titled: “Remote Operations In The Presence of High Latency Communications”.

### BACKGROUND OF THE INVENTION

It is well known that remotely operating a vehicle in the presence of substantial communication latency is a very difficult proposition. Prior art systems typically are limited to driving the vehicle at very slow speeds; this system overcomes those limitations.

### SUMMARY OF THE INVENTION

Images captured by cameras on the vehicle are processed and then compressed for transmission over the limited bandwidth connection to the remote driver. Other sensors on the vehicle collect information which is transmitted to the remote driver as well as aiding in the processing and compression of visual information. On the receiving end the images are decompressed and, along with other sensor information, are enhanced for the remote driver. The remote driver observes the enhanced images and other sensor information and provides trajectory information which is transmitted back to the remote vehicle. The vehicle receives the trajectory information, relocalizing it to correct for bi-directional transmission delays and other errors, providing lateral and longitudinal controls accordingly.

### BRIEF DESCRIPTION OF DRAWINGS

FIG. 1 shows a system diagram of a remotely operated vehicle.

FIG. 2 shows a detailed diagram of the driver station.

FIGS. 3-6 show detailed diagrams of the data processing system.

FIG. 7 shows a portion of a prior art video compression system.

FIG. 8 shows a portion of a video compression system.

FIGS. 9 and 10 show images from the vehicle camera.

FIGS. 11-14 shows the definition of certain visual parameters in the geometric correction process.

### DETAILED DESCRIPTION OF THE INVENTION

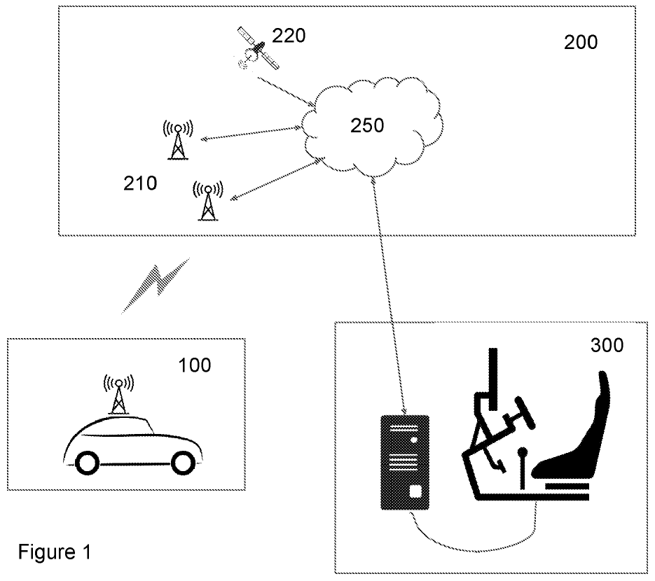

FIG. 1 shows a system diagram of a remotely operated vehicle. Vehicle 100 captures images and sensor data which are transmitted via communications system 200 to driver station 300. A human (not shown in figure) monitors the captured images and in response manipulates the controls of the driver station to generate a trajectory. The generated trajectory is transmitted via communication system 200 to vehicle 100. Vehicle 100 receives the trajectory and operates to follow said trajectory. Communication system 200 can use any wireless data transmission technology including both terrestrial-based (210) and/or satellite-based (220) as well as wire-based (i.e., internet 250) to convey data between vehicle 100 and driver station 300. Communication system 200 may provide multiple paths for data to be transmitted between vehicle 100 and driver station 300.

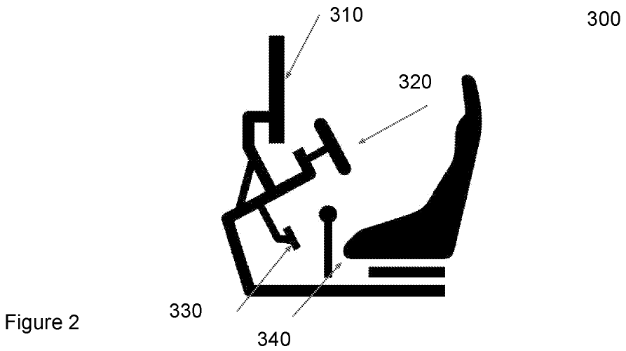

FIG. 2 shows a detailed diagram of the driver station 300. Display 310 provides video images for the human driver (not shown). In a preferred embodiment, steering wheel 320, one or more pedal controls 330, and gear selector 340 are operated by the human to direct the operation of vehicle 100. In alternate embodiments, other input devices such as joysticks, pointing devices (e.g., Wii remote), buttons, levers, switches, pushbuttons, gear shifts, etc. might be operated by the human to direct the operation of the vehicle 100; they will be considered equivalent within this description.

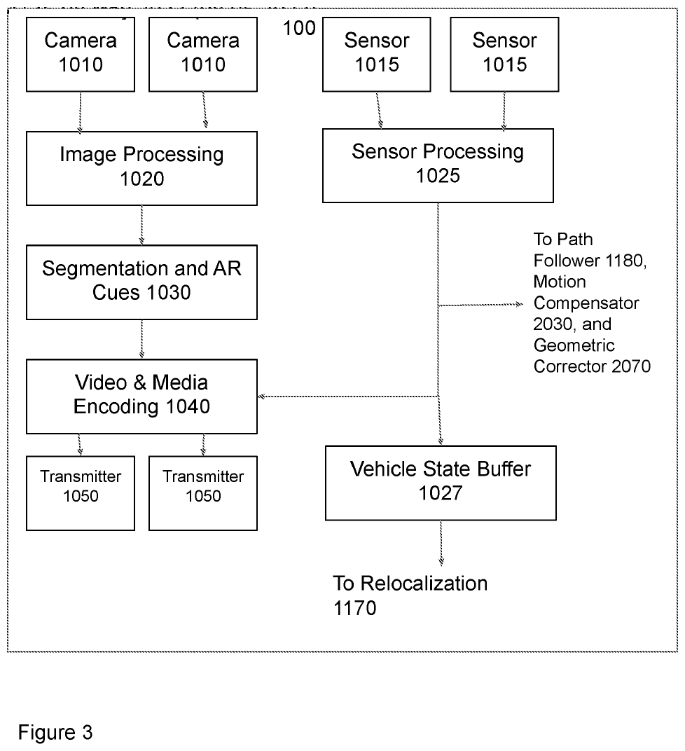

FIG. 3 shows a detailed diagram of the vehicle sender portion of the data processing system of vehicle 100. One or more cameras 1010 capture images which are forwarded to Image processing unit 1020. Image processing unit 1020 enhances the images and forwards them to segmentation and augmented reality (AR) cues unit 1030. Video and media encoding unit 1040 compress the images and format them for transmission via one or more transmitters 1050. One or more sensors 1015 capture vehicle state telemetry data which are processed by sensor processing unit 1025 and forwarded to video and media encoding 1040, path follower 1180, and vehicle state buffer 1027. Forwarded vehicle state telemetry data is processed by video and media encoding 1040 which formats them for transmission via one or more transmitters 1050.

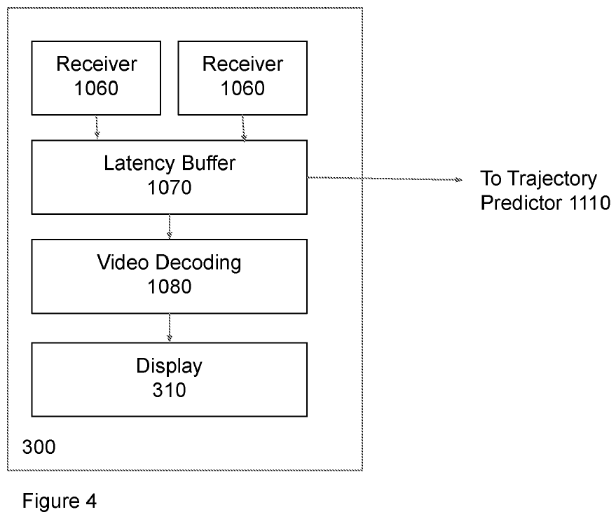

FIG. 4 shows a detailed diagram of the receiver portion of driver station 300. One or more receiver units 1060 receive data sent from transmitters 1050 over communications system 200 and place it into latency buffer 1070. Image data removed from latency buffer 1070 is processed by video decoder 1080 and displayed by display 310. Telemetry data removed from latency buffer 1070 is forwarded to trajectory predictor 1110.

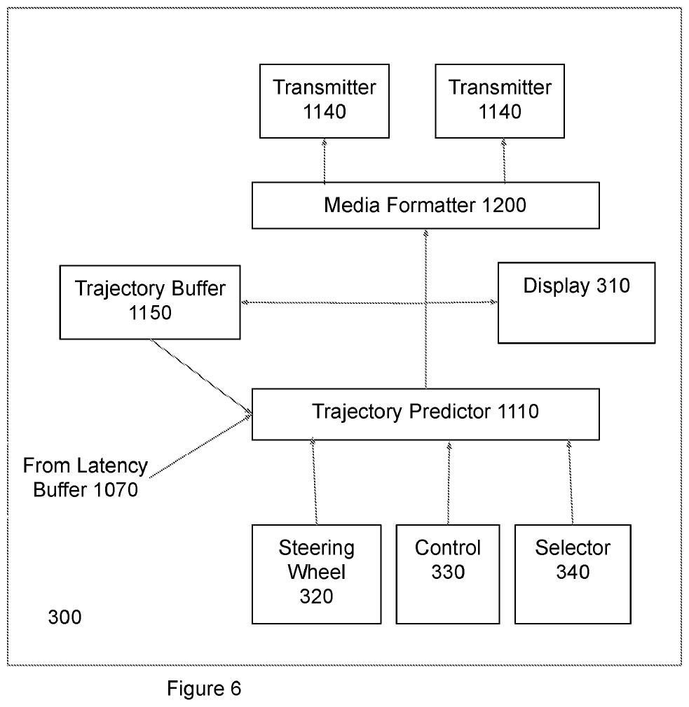

FIG. 6 shows a detailed diagram of the sender portion of driver station 300. Trajectory predictor 1110 collects data by periodically sampling steering wheel 320, pedal controls 330, and gear selector 340. Sampled data are combined with vehicle state telemetry data from latency buffer 1070 and historical trajectories from trajectory buffer 1150 to predict a new trajectory. The new trajectory is displayed by driver display 310, stored in trajectory buffer 1150, and sent to media formatter 1200 for transmission by one or more transmitters 1140.

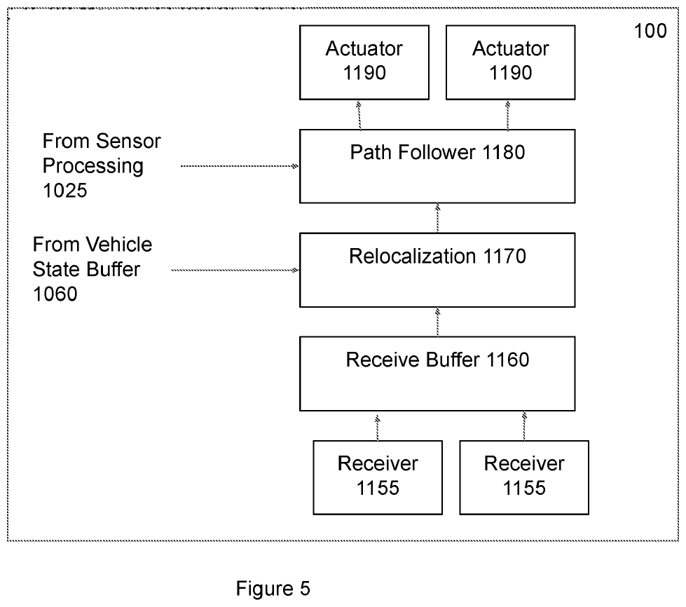

FIG. 5 shows a detailed diagram of the receiver portion of vehicle 100. Trajectories are received by one or more receivers 1155 and stored in receive buffer 1160. Trajectory information from receive buffer 1160 and historical vehicle state information from vehicle state buffer 1027 is used by relocalization unit 1170 to generate a local path. Path following unit 1180 uses the local path and the current vehicle state telemetry from sensor processor 1025 to control one or more actuators 1190 that directly control the vehicle (steering, engine, brake, etc.).

Sensor processing unit 1025 uses data from one or more sensors 1015 to compute vehicle telemetry such as relative position, velocity, heading, acceleration, angular acceleration, etc. Many methods of doing these computations using different combinations of sensors are known. Purely internal schemes are known which may use wheel speed, wheel deflection and/or an inertial measurement unit (IMU) such as the NavChip ISNC02 from Thales Visionix, VN-100 from VectorNav, 3DM-CV5-IMU from Lord, ASM330LHH from ST, etc. Purely external schemes using satellite and/or fixed-terrestrial radio location schemes are also known, e.g., GNSS (GPS, GLONASS, BeiDou, Galileo, etc.), LORAN, and GPS RTK (real time kinematics). Images from camera 1010 can also be processed by image processing 1020 to yield velocity and odometry information. Any of these schemes that provides a sufficiently accurate velocity and odometry can be used. In a preferred embodiment, sensor processing unit 1025 uses sensor fusion techniques (e.g., a Kalman filter) to combine multiple sources of velocity and odometry sensor information.

Substantial data is transmitted between vehicle 100 and driver station 300. It is well known that wireless transmission is error prone, meaning that the overall system must be prepared to deal with a meaningful percentage of transmitted data either not being received or being corrupted. Error detecting codes are added to transmitted data such that a receiver can detect corruption with a suitably high confidence. In a preferred embodiment, corrupted data is discarded and treated similarly to lost or missing data. As a technique to address the unreliable delivery nature of the wireless media, redundancy can be used to increase the likelihood of certain data being received successfully. Redundancy can be injected by transmitting additional data that allows a receiver to reconstruct the original data if only a portion is received. Many forms of this are known in the literature including, fountain codes, Reed-Solomon codes, parity codes, turbo codes, etc. An additional dimension of redundancy is possible by using multiple transmission channels, transmission via multiple antennas (i.e., multiple satellites and/or multiple terrestrial antennas, e.g., cell towers, etc. or some combination of these), or multiple networks, i.e., different cell network providers. Any or all of these techniques either alone or in combination are possible. In a preferred embodiment, the sender has at least two sources of information about current network conditions. A first source of information is from receiver 1060 which reflects statistics about received data back to video and media encoder 1040 via transmitter 1140 and receiver 1155 (this path is not shown on the diagram for clarity). A second source of information is transmitter 1050 which collects statistics on its ability to access shared network 200 and data transmission rates, e.g., for cellular or satellite media, transmitter 1050 uses a protocol to obtain temporary permission to transmit data to network 200, said permission including information that determines the effective data transmission rate, i.e., power levels, modulation techniques, and channel lease times. This allows the transmitter to dynamically select amongst the multiple redundancy injection techniques. Yet another dimension of redundancy is to estimate missing data by looking at prior data, e.g., missing image data may be assumed to have similarity to previously received image data or missing telemetry could be estimated by using previously received telemetry (e.g., predict changes in position by examining previous positions, velocities, headings, and accelerations).

Not all data need be subjected to the same level of redundancy injection nor the same redundancy techniques. Data can be prioritized, allowing allocation of redundancy to be applied differentially in response to current (i.e., limited) bandwidth conditions. In a preferred embodiment, vehicle telemetry and trajectory information are prioritized over image information. Some data, such as image data, can be reduced in accuracy or quality (i.e., compressed) to meet current estimates of network bandwidth. Many well-known image compression techniques are available to reduce the quantity of image data so that it fits into the current estimate of network conditions.

The system of FIG. 1 can be considered as a pipeline. The pipeline originates with cameras 1010 and sensors 1015, flowing through the units of FIG. 3. The transmission of data from transmitter 1050 to receiver 1060 comprises additional pipeline stages. Driver station 300 (FIGS. 4 and 6) contributes more pipeline stages. The transmission of data from transmitter 1140 to receiver 1155 comprises additional pipeline stages. Finally, the units of FIG. 5 may also contribute pipeline stages.

Trajectory predictor 1110 operates by periodically combining recently received vehicle telemetry (e.g., relative vehicle position, heading, velocity, angular velocity, acceleration, angular acceleration, etc.) taken from latency buffer 1070 with historical trajectories stored in trajectory buffer 1150 to predict the current state of the vehicle. In a preferred embodiment, the current location of the vehicle is expressed relative to a past location of the vehicle rather than with reference to any external coordinate system. In a preferred embodiment, trajectory predictor 1110 uses vehicle telemetry coincident in time with the capture of the image to be displayed by display 310. Prediction of the current location is done by assuming that vehicle 100 follows the historical trajectories (still to be received by vehicle 100). In a preferred embodiment, trajectory predictor 1110's prediction is performed using the same vehicle model as used by path follower 1180.

Once the predicted current state of the vehicle has been computed, trajectory predictor 1110 uses sampled values of driver station controls steering wheel 320, pedal controls 330, and selector 340 to predict future states of the vehicle. The computation of the future predicted states is done using a kinematic or dynamic model of the vehicle. In a preferred embodiment the computation of the future predicted states is performed using the two-wheel bicycle method.

In a preferred embodiment, the states of the vehicle from the point in time associated with the recently received vehicle telemetry through to the current time and into the future are converted into visual form and shown on display 310. Conversion of the states of the vehicle into graphical form for display is straightforward provided that the transformation between the vehicle coordinate system and the camera coordinate system (and thus the display coordinate system) is known. In a preferred embodiment, perspective-correct 3D graphical techniques are used in the conversion from vehicle to display coordinate systems. In a preferred embodiment the graphical form may be augmented with telemetric information such as current vehicle velocity and heading information.

Relocalization unit 1170 operates to adjust trajectories received in receive buffer 1160 due to variance between the vehicle location predicted by trajectory predictor 1110 and the actual location of the vehicle as determined by sensor processing unit 1025. Relocalization unit 1170 can repeat some of the computation of trajectory predictor 1110 except that instead of using transmitted trajectories for a prediction the relocalization unit uses actual historical vehicle state information (stored in vehicle state buffer 1027). The difference between the received trajectory and recomputed trajectory is used to adjust the received trajectory before it is passed to path follower 1180.

Path follower 1180 receives a trajectory from relocalization unit 1170 as well as current vehicle state information from sensor processor 1025. Path follower through actuators 1190 operate to control the lateral (steering) and longitudinal (brake, engine, etc.) progression of vehicle 100. Path follower 1180 can use any combination of the well-known algorithms, including: Stanley controller, model predictive control, PID, linear quadratic Gaussian, and other so-called optimal methods to direct the vehicle to follow the trajectory. Many apparent constants of the algorithm such as vehicle weight, acceleration, braking, tire wear, tire inflation, etc. may change over longer time horizons (minutes, days, months, etc.) and these must be kept updated. Other events may require updates to algorithm parameters. For example, a pothole on the road may cause a persistent change in the wheel alignment, requiring a different force pattern on the wheel deflection actuators. All of these can be accommodated and corrected by monitoring the vehicle telemetry and feeding that back into the model.

In an embodiment, path following is divided into lateral and longitudinal following, with path follower 1180 responsible only for performing lateral trajectory following, while the driver station 300 transmits brake and engine control signals directly to provide longitudinal control.

### Image Processing

The processing of images (see FIG. 3) by the vehicle in preparation for transmission contains multiple stages. Generally, the stages are arranged in a pipeline fashion with the output of one stage feeding the input of the next stage. However, processing of images may be broken up into sections or pieces thereof to allow processing of subsequent stages to begin while earlier stages are still processing other portions of an image. Thus, even though this specification describes separate stages with an order, this description is conceptual and provided to ease the description, the practitioner may choose to perform the computations in an order other than described and may choose to combine one or more described stages into a single to multiple steps or phases of computation. Many of the processing stages utilize not just the current image but previous images as well as previously computed information. However, because of camera motion during the elapsed time between successive images, the system may need to compensate to locate and/or interpolate information from previous images. As the system has available detailed information about the motion of the camera (sensor processing 1025) which can be utilized in the compensation process in addition to more typical motion compensation techniques like hierarchical similarity search.

One image processing stage compensates for degraded images due to bright sunlight and/or oncoming headlights. These include glare, sun flare, blooming, etc.

Another image processing stage compensates for the visual degradation of atmospheric things like rain, snow, fog, and smoke which are referred to as deweathering. Many algorithms are described in the literature for deweathering. However, driving has special requirements as well as additional information from normal deweathering situations primarily due to the predictable motion of the camera. The interactions of the algorithms for deweathering and other image processing steps (segmentation, see below) are also interesting.

Another image processing stage identifies and prioritizes portions of an image referred to as segments. Machine learning and computer vision techniques are used to perform the segmentation and prioritization. The prioritization (high to low) indicates which segments are of high or low importance for viewing by the remote driver. Segments containing items which are known to be of interest to the driver, e.g., signs, lane markers, other vehicles, brake lights, on-lane debris, potholes, etc. are given a higher priority. Segments that are not recognized or whose recognition is of questionable quality may also be given a higher priority. Segments containing items known to be of little importance to the driver are given lower priority, e.g., buildings, vegetation, clouds, etc. The prioritization process can be context dependent, incorporating such elements as location, velocity, and/or heading into the process. For example, a bird in the sky is given a very low priority—but a bird on the roadway is given a high priority. Another example is a moving vehicle. A moving vehicle on an overpass is low priority. A moving vehicle in my lane or a directly opposing or intersecting lane is a high priority.

Image segmentation and prioritization information can be used in many places in the processing when resources are scarce. For example, during video compression the priority may be used to influence the allocation of scarce bandwidth, causing low priority segments to be reproduced with reduced fidelity. Similarly, scarce computational resources can be allocated using segment priority, meaning that high priority segments will have better reduction of glare and de-weathering than lower priority segments though this will increase latency and is not desirable in some implementations.

In a preferred embodiment, there are a fixed number of priority values. For each priority value a total of the number of segments or pixels which are assigned that priority value is maintained. These totals are used to provide approximate bandwidth allocations for the priority levels. The approximate bandwidth allocations for each priority level is combined with the total number of segments or pixels at that priority level to compute a per-segment or per-pixel bandwidth allocation. This bandwidth allocation is used as a target value in setting the segment compression algorithm parameters, i.e., quantization levels of encoder 2060.

Even in the presence of abundant resources the segment prioritization can be useful. For example, the portions of the video data encoding higher priority segments can be transmitted using higher levels of error correction and redundancy than the lower priority segments, providing increased fidelity in the presence of media errors and lost packets.

The coding (compression) of a video frame is performed. There are many standards for coding video data that can be used. A key element of the frame coding is that it must be encodable and decodable within a latency budget. This will tend to restrict techniques wherein the coding of a video frame refers to portions of a future video frame (like a “B” frame in MPEG). For example, it may be only possible to refer to a limited number of frames in the future, e.g., one. In a preferred embodiment, forward references are eliminated so as to avoid any increased latency.

Because of the information about current network conditions (see above), the system has an estimate of the total available bandwidth and likelihood of successful reception by the remote receiver. The video frame and any associated vehicle status information (e.g., telemetry) and any other data scheduled for transmission to the remote driver are then processed to create the multiple transmission path data streams. The processing of the data involves the addition of forward-error correcting codes as well as the allocation or assignment of the data to the specific transmission path. Another factor in the processing is the priority of the video segments. The combination of known transmittable data bandwidth and video segment priority may be used to control the compression (and hence the video quality) of the video segment. In extreme cases, a video segment could be compressed down to just the segment metadata, requiring the receiver to be able to construct a simulation of the video segment. For example, a segment identified as “sky” is given a low priority. During periods of bandwidth scarcity, the transmitter sends only the segment metadata, requiring the receiver to reconstruct this portion of the image using a locally sourced sky image or substitute (suitably scaled and placed into the reconstructed image).

While the data may be transmitted through multiple paths, the data eventually is routed to the remote driver station 300. Statistics about the received data are collected for each of the transmission paths (which packets arrived, in or out of order, drop percentages, arrival variances, etc.) which are also transmitted to the remote vehicle to help maintain its version of the status and quality of the different transmission paths. From the data the receiver extracts the encoded video frame and any other control, administrative, or telemetric data that accompanied it.

The received data is reassembled and placed into latency buffer 1070. The latency buffer can store multiple received frames with their associated data. The latency buffer serves to compensate for latency and rate variance in the transmission paths by regulating the delivery of video frames (and associated data). While decompression could be performed either before or after data is placed into the latency buffer, in a preferred embodiment the decompression is done before insertion into the latency buffer, allowing the same latency buffer to also compensate for the variable time required to decompress an image. The system maintains an estimated current transmission latency and uses the latency buffer to delay the arrival of data to match the estimated latency, i.e., each inserted frame has a target removal (delivery) time. Typically, the estimated current transmission latency is set to a latency value based on the currently estimated transmission path capacity and latency variance that provides a high percentage of video frames arriving within the estimated latency value, typically 99.9% or 99.99%. Statistics about the dynamic behavior of the latency buffer are also fed into the transmission path quality estimates both locally and remotely.

The system monitors the recently observed latency and rate variance values and may determine that it wishes to adjust the target latency in the latency buffer. Generally, it is undesirable to abruptly make large changes in the target latency as this will tend to degrade the driver's experience as the system would drop frames or be forced to repeat frames in cases of large decrease or increases, respectively. Rather, it is desirable to gradually change the target latency over a period of multiple frames to avoid or minimize these effects.

If communication is sufficiently degraded over a large enough time horizon or for other safety reasons, the vehicle determines that remote operation is no longer feasible and engages a “safeing” mode. The safeing mode brings the vehicle to a safe stop. In an embodiment, the vehicle utilizes a local lane keeping capability and engages the braking system to safely stop the vehicle. In an alternate embodiment, more sophisticated local semi-autonomous software is engaged to bring the vehicle to a preferred lane or shoulder as it stops.

At the targeted removal time for a frame, it is removed from the latency buffer and prepared for display 310. The preparation process consists of three parts. Firstly, the video data is obtained from the latency buffer. Secondly, administrative, telemetric, and instrumental data are converted into graphical format for display. Examples of instrumental data include vehicle status information such as current speed and direction, network status information, etc.

Part of the above processing may allow the image to be further enhanced using the segmentation information. Examples include enhancing the text on traffic signs, indicating vehicles that are potential obstacles in the path, highlighting road and lane markers, providing navigational information, etc.

Like latency buffer 1070, the receive buffer 1160 is used to smooth out latency variances. The system utilizes an estimate of the return transmission path latency and variance to compute a residency time for the receive buffer which will ensure that a suitably high percentage of the return data has been received by the vehicle within the estimated time.

As vehicle trajectory information is removed from the receive buffer (because its time has arrived), it is subjected to relocalization to adjust the transmitted trajectory information to account for the transmission delay (as well as the delay in the receive buffer) and intervening vehicle movement. The adjusted trajectory information is used to provide a path for the vehicle to follow.

The trajectory predicted by trajectory predictor 1110 consists of two parts. The first part is the immutable path prediction. The second part is the mutable path prediction. Typically, the two parts are displayed in the same frame optionally with visual differentiation, e.g., different colors for the two parts.

The immutable path prediction represents the expected path traveled by the vehicle before any possible change in trajectory can be communicated to the vehicle. The immutable path prediction is computed by combining the received state of the vehicle together with the historical trajectories from trajectory buffer 1150.

The computing and/or drawing of the immutable path prediction can be performed with higher or lower precision. A lower precision version can be constructed solely from trajectories transmitted to the vehicle. In a preferred embodiment, a higher precision version can be constructed by taking the lower precision and adding to it an estimation of the trajectory-following behavior of the vehicle as computed at the driver station. The estimation could use the vehicle state information (telemetry) such as the wheel deflection, wheel deflection change rate, speed, acceleration, braking, delta from requested trajectory, road inclination, etc. which might be transmitted from the vehicle along with video frame information. The estimation could use slower changing information such as vehicle weight, tire inflation, tire wear, brake wear, etc. which might have been transmitted infrequently or upon change.

The mutable portion of the prediction is computed by combining the path prediction from the immutable prediction together with the current local driving controls (320, 330, and 340) and a model or estimation for the behavior of the vehicle upon receiving the new path prediction (trajectory). The time period for the mutable portion of the prediction is not directly implied by the state of the system-unlike the immutable portion of the prediction. One option for the time period is to simply use a constant value, say one second or more. Another option is to utilize the communications round trip time (something the system monitors to properly operate the latency and return buffers) or some proportion thereof, having the advantage of visually signaling the driver when communications are being delayed, degraded, or otherwise impaired.

Sometimes, the communication system will fail to deliver new frames for periods of time that exceed the ability of the latency buffer to compensate. In these cases, the path prediction system may continue to display updated mutable and immutable path predictions based on the most recently available frame. This situation will be noticed by the driver who can react accordingly.

It can be advantageous to alter the displayed images based on the new trajectory set by the driver. In an embodiment, the vehicle captures and transmits a wider field of view (FOV) than is displayed at the driver station. The display system uses the current steering wheel 320 setting to determine which portion of the wider FOV is displayed, simulating the visual effect of the turning of the vehicle immediately at the driver station rather than waiting for the turn to become visible in the vehicle captured images.

The path prediction may use non-visual sensory modalities to communicate with the driver. Force feedback (rumble, shaking, resistance, back-pressure, etc.) in the local control input devices can be generated based on the immutable and mutable trajectories and other vehicle state and driver station state information (brake, accelerator, steering wheel settings, etc.).

Conventional lane keeping can also be provided. One implementation of this would be to have the driver's system evaluate the incoming data and then to generate the correct trajectory directly from that information.

Collision detection and avoidance systems are well known. In their simplest form they monitor for potential collisions. When a potential collision is deemed to be imminent, the driver is notified (usually audibly and visually) and optionally braking is automatically engaged. These systems can be deployed locally with notification being transmitted to the remote driver or remotely by notifying the driver at the driver station.

Relocalization is the process of compensating for the delays associated with communications over distance. A trajectory removed from the receive buffer 1160 was generated by the remote driver at a time in the past based on data originally transmitted by the vehicle from a time even further in the past. During this time substantial movement of the vehicle has occurred, some of which will be taken into account by the new trajectory but some of the movement cannot. Movement that cannot be accounted for may come from several sources. One source of unaccounted movement is the external forces on the vehicle, e.g., changes in wind speed and direction, irregularities in the road surface (potholes, bumps, inclination changes, etc.), etc. Another source of unaccounted movement is the trajectory-following activity of the vehicle. Another source of unaccounted movement is internal forces within the vehicle, e.g., tire wear, weight distribution changes, engine irregularities, braking irregularities, etc. Another source of unaccounted movement is the inherent error in the predictive modeling of the vehicle done by the system.

One realization of the relocalization process has two steps. In the first step, the trajectory removed from the receive buffer 1160 is converted from its historic vehicle-based coordinate system into an alternate coordinate system. In the second step, the trajectory is converted from the alternate coordinate system into the current vehicle-based coordinate system. Any coordinate system that can be understood by both the remote driver system and the vehicle system independent of time may serve as an alternate coordinate system.

One form of alternate coordinate system could be a geographic coordinate system (see https://en.wikipedia.org/wiki/Geographic_coordinate_system). Using this form of alternative coordinate system requires the ability to generate a high-precision location. Methods of generating a high-precision location are either intermittent or expensive (or both) and are thus not desirable.

Another form of alternate coordinate system would be a historical vehicle-relative system. In this alternate coordinate system, locations would be specified relative to the location of the vehicle at some fixed point in time. Essentially this would be the equivalent of a local coordinate system using the historical position of the vehicle as the origin. Using this kind of system requires the ability to precisely gauge distances relative to the vehicle which can be difficult for something that is only visible through a camera. Additional information from other sensory modalities (radar, ultrasound, etc.) may make this mechanism easier.

In a preferred embodiment, an inertial measurement unit (IMU) optionally augmented with other vehicle telemetry (velocity, heading, etc.) provides a high-resolution estimate of vehicle state changes over short periods of time, simplifying the process of relocalization.

Another form of alternate coordinate system is an object-relative system. In this form, references are made relative to objects that have been identified by the segmentation mechanism. These references could be in the form of deltas from one particular object or multiple objects. Normally, it would be considered redundant to specify multiple deltas from multiple objects as the basis of a reference—as this would be considered an overspecification. However, estimating distances from camera images is inherently error prone and by providing this overspecification this source of error can be reduced sufficiently to be considered eliminated.

Not all objects are good bases for references. Objects that are immobile are the best. Objects that are in motion can be used provided that a reasonable estimation of the motion of the object is available (or computable). Again, as with camera distance estimation error, providing multiple deltas from multiple objects will tend to eliminate motion estimation error. Other sensory modalities can also be used to enhance or largely eliminate motion estimation error.

The algorithms to perform segmentation, glare removal and deweathering can be performed serially or in parallel. In the parallel situation, the algorithms are run separately, and their results are combined afterwards, or their multiple computations are combined to accomplish the same. Several possible serial configurations are feasible.

One serial configuration is to perform glare removal and deweathering followed by segmentation. This has the advantage of allowing segmentation to operate on a clearer version of the image.

Another serial configuration is to perform segmentation followed by glare removal and deweathering. This configuration can be advantageous in that the segments with a low priority need not necessarily be processed by the deweathering, reducing the amount of computation required.

Yet another serial configuration would be to perform a first deweathering followed by segmentation followed by a selective application of a second deweathering. In this configuration, the first and second deweathering algorithms are not necessarily the same algorithm. The second deweathering step is selectively activated only on specific segment types. The selective application of the second deweathering algorithm allows the usage of an algorithm tailored to just those types. One specific segment type that would benefit from secondary deweathering would be signage in that signs are known to be primarily text and other graphic-like images (interstate, vs. US highway, vs. local roadway signs, etc.)), allowing the second algorithm to be optimized for this subset of visual information.

The segmentation process aids in the identification of objects in the image. It may be advantageous to perform additional processing on some of the identified objects. Some of the processing may be limited to providing a visual cue to the driver. This could be as simple as visually highlighting the object, e.g., outlining the object in a more visible or informative color scheme. Other forms of processing may gather additional information or make explicit inferences that are then conveyed to the driver.

One example is that objects that are in motion can be tracked from frame to frame and have their relative motions estimated. This estimation could be used to infer whether the object represents a navigational hazard. Objects determined to be a navigational hazard could be highlighted or otherwise emphasized to call the driver's attention to them. This is an extended version of the typical collision detection system.

Another example is that key navigational items can be explicitly highlighted. For example, lane markers, signs, potholes, etc. can be highlighted.

Another example is that signage can be recognized, converted to text (i.e., optical character recognition—OCR, or equivalent) and scanned for semantic content. Based on the semantic content the system could choose to highlight or lowlight the signage. Other actions beyond simply high- or low-lighting the image of the sign include recommendations for lane changes or detours (roadwork ahead, delay ahead, road closed, etc.), speed change suggestions, etc.

The scanning for semantic content can be location aware. For example, while scanning a sign, having knowledge of local road, business, landmark, and city names can help resolve potentially ambiguous situations. In this case, the location need not be established with high precision, allowing inexpensive GNSS technologies to be used.

Other location and destination-aware operations can be provided. Real-time directions and suggestions for navigation can incorporate the latest road conditions can be provided (like well-known applications such as Google Maps, Waze, etc.). With the appropriate software technology (that proxies the location and handles the output) those actual applications can be executed by driver station 300 and have their output also be displayed to the driver.

Other sensors beyond cameras can be used also. Sensors based on LIDAR, IR, RADAR and ultrasonic also provide data about the environment. This data can be used to augment the information gleaned from the visible spectrum (i.e., the cameras). For example, in poor lighting conditions (fog, smoke, nighttime, etc.) these other sensor types can be used to assist the entire segmentation and object recognition pipeline. It's possible that objects undetected in the visible spectrum may be sufficiently detected using the other sensors sufficient to feed into the segmentation and object recognition process leading to their being visually presented to the driver. For example, in heavy fog, a vehicle on a collision course could be detected and the driver could be notified—even though it was completely invisible to the cameras.

It is desirable to enable other human sensory mechanisms beyond vision. For example, it is advantageous for the remote vehicle to capture one or more streams of audio for transmission to the remote driver. When multiple streams can be used it is possible to reproduce audio that includes spatial location cues (stereo, etc.). Audio, with or without spatial location information, can enhance the quality of the driving experience as well as increase safety just as in non-remote driving (e.g., hearing an emergency vehicle before it can be seen, hearing a problem in a tire before a blowout occurs, etc.).

Using the human's haptic sense the system can communicate additional sensory information, such as road conditions (bumpy, smooth, etc.), speed, etc.

Stimulating the driver's proprioceptive senses can be used to convey information such as lateral G-forces or vehicular orientation, etc.

The inherent nature of the driving environment allows the video compression process to take advantage of additional information, not available in normal video compression situations, to substantially reduce the number of bits required to code a piece of video or to enhance the quality of the encoded video without substantially increasing the number of required bits.

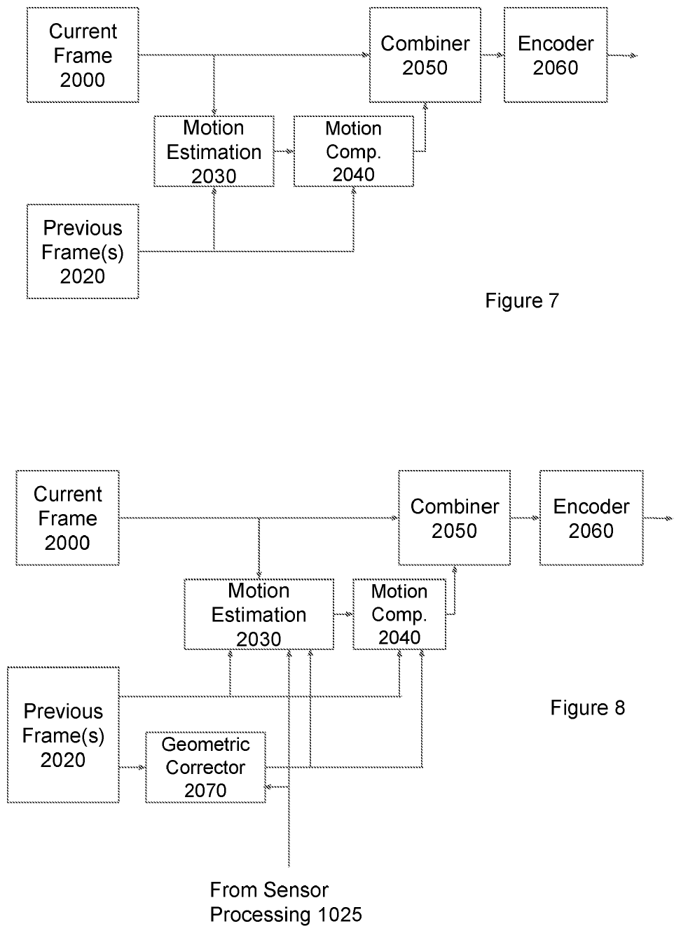

FIG. 7 shows a portion of a prior art video compression system. Current frame 2000 is divided into blocks of pixels, typically each block is square with 8, 16, 32, or 64 pixels on a side. For each block in current frame 2000 (current block), motion estimator 2030 selects from one or more previous frames 2020 the blocks which are most similar to the current block (most similar blocks). Typically, the selection process is performed by searching. The coordinates of these blocks are sent to motion compensator 2040. Note that the coordinates of the most similar blocks may be fractional, typically specified in half- or quarter-pixel units. Motion compensator 2040 uses the coordinates to access previous frames 2020, generating a referenced block. When fractional pixels are used, motion compensator 2040 applies well-known appropriate sampling and filtering in the generation. Combiner 2050 computes the difference between the current block and the referenced block, sending the differences to encoder 2060. Encoder 2060 converts the differences into a bit stream through a process known as quantization and includes data indicating the source of the referenced block, i.e., the fractional coordinates.

FIG. 8 shows a video encoder modified to include geometric corrector 2070. As described below, geometric corrector 2070 can be used to generate alternative previous frames or portions thereof from the one or more previous frames 2020. Motion estimator 2030 uses vehicle telemetry information from sensor processing 1025 to include blocks from the alternative previous frames as candidates for most similar blocks. Motion compensator 2040 uses blocks from alternative previous frames as directed by motion estimator 2030. In a preferred embodiment, motion estimator 2030 uses the vehicle telemetry information to indicate an initial starting point for a hierarchical search of an alternative previous frame for a most similar block.

Geometric corrector 2070 operates by using its knowledge of the position of camera 1010 and of the motion of the vehicle (i.e., vehicle telemetry from sensor processing 1025) from one previous frame 2020 to the current frame (or from one previous frame to another previous frame) to generate one or more alternative previous frames or portions thereof.

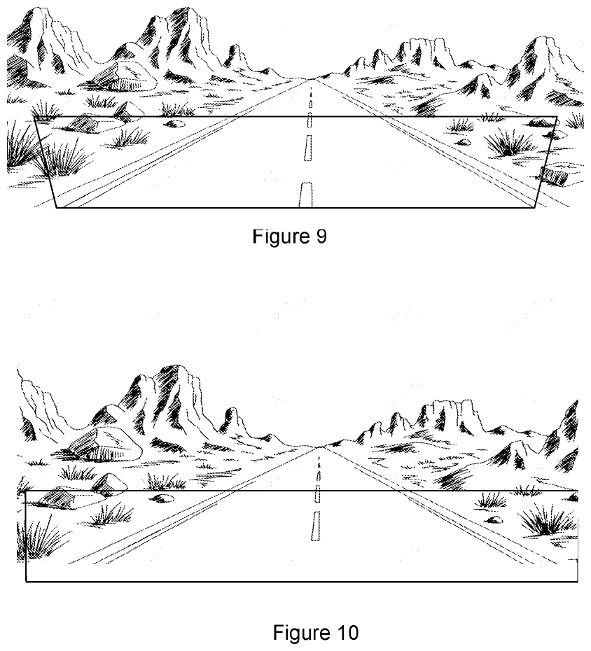

FIGS. 9 and 10 represent images captured by camera 1010 as the vehicle moves forward down a road, with FIG. 9 preceding FIG. 10 in time. Objects in FIG. 9 are larger in FIG. 10 in relationship to their distance to the camera. This causes substantial distortion of the portions of the image that are close to the vehicle. The visual content of the trapezoidal area of FIG. 9 becomes the rectangular area of FIG. 10, distorting the pixels therein accordingly.

Well-known 3D geometry can be used to generate FIG. 10 from FIG. 9 if the height and location of each object in FIG. 9 was known as well as the position, orientation, and visual parameters of the camera (FOV, aperture size, focal length, etc.).

For reference purposes, each image is considered to have W horizontal pixels, numbered left to right from −W/2 to +W/2 and H vertical pixels numbered top to bottom from −H/2 to +H/2. X is used as the horizontal coordinate and Y as the vertical coordinate.

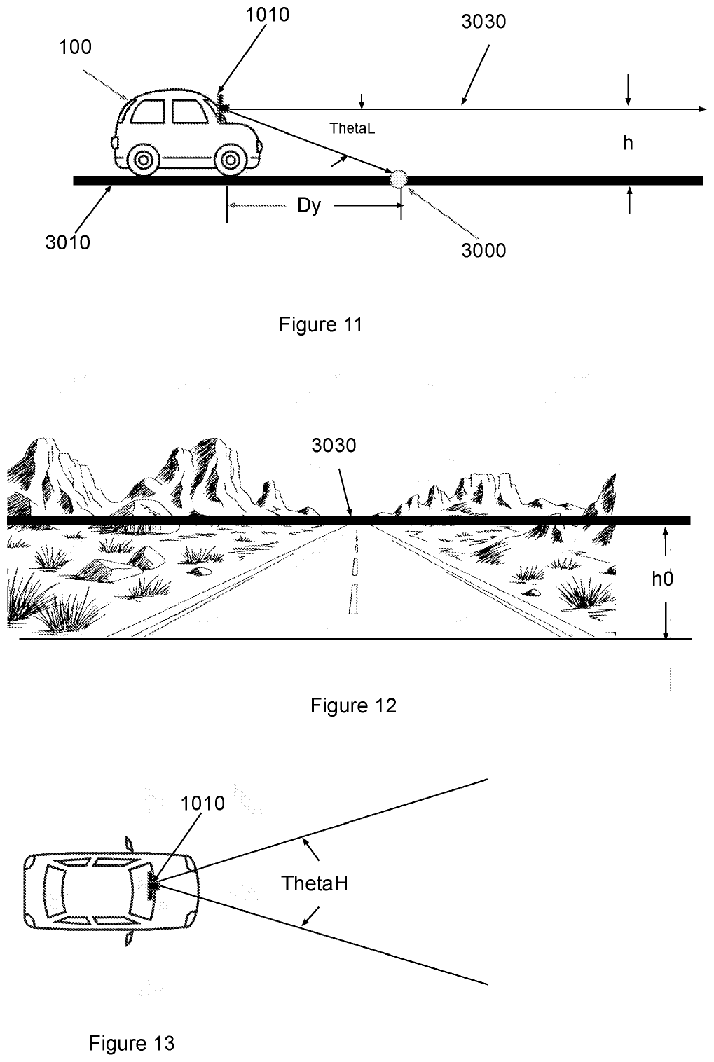

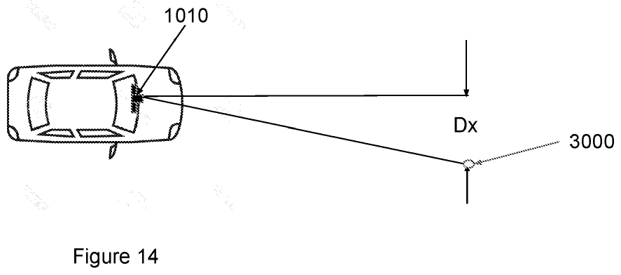

FIG. 11 shows some of the reference points used by geometric corrector 2070. Vehicle 100 is upon roadway 3010. Camera 1010 is mounted on vehicle 100 at a height of h above roadway 3010. Horizontal line 3030 is parallel to roadway 3010 at the same height of h. For each pixel in an image, Intercept point 3000 is the projection of that pixel onto the roadway 3010. The quantities Dx and Dy are the distance from the vehicle to intercept point 3000 (Dy is labelled in FIG. 11, Dx is shown in FIG. 14). ThetaL is the angle subtended between horizontal line 3030 and the intercept point at the bottom middle of the image (X=0, Y=−H/2). ThetaL can be measured or computed from vehicle and camera parameters (height, orientation, pitch, focal length, image size, aperture, etc.). FIG. 13 shows ThetaH as the angle subtended by the entire horizontal field of view of camera 1010.

FIG. 12 shows that h0 is the Y coordinate of horizontal line 3030. If the vehicle is on level ground, h0 will be the Y coordinate of the horizon.

Geometric corrector 2070 generates alternative previous images as follows. Pixels above h0 have no correction applied, i.e., these pixels will be the same as in previous frame 2020. Pixels below h0 are corrected by assuming that each pixel of the previous frame 2020 represents a portion of an object which has a vehicle-relative height of zero (i.e., the same height as the corresponding intercept point 3000) and has a known motion relative to the vehicle. Correction is performed by computing the location of the pixel of the object as shown in previous frame 2020, adjusting that location using the known vehicle-relative motion of the object, and placing the pixel of the object into the alternate frame at the adjusted location.

The equations:

$$Dy ( Y ) = \frac{h * h 0}{tan ( ThetaL ) * Y}$$

$$Dx ( X ) = 2 * Dy ( Y ) * X * \frac{tan ( \frac{ThetaH}{2} )}{W}$$

Are the computed Dx and Dy for each pixel at location X and Y.

In a preferred embodiment, Geometric Corrector 2070 assumes that all objects have a vehicle-relative motion that is the inverse of the vehicle motion (i.e., they are stationary) and that the vehicle is moving straight ahead (i.e., not turning). Using the label delta to be the distance travelled forward during the time between the previous and current frame, then the final equations are:

$$Yalt = \frac{y * h 0}{h 0 + Y * tan ( ThetaL ) * ( \frac{delta}{h} )}$$

$$Xalt = X * \frac{Yalt}{Y}$$

Where Xalt,Yalt is location in the alternate frame of a pixel whose location is X,Y in the previous frame.

1. A method for remotely operating a vehicle by a driver comprising the steps of:
gathering data from sensors coupled to a vehicle;
sending said data to a driver station;
receiving navigation from a driver;
computing a trajectory;
transmitting said trajectory to said vehicle;
relocalizing said trajectory; and
instructing said vehicle to follow said trajectory.

2. The method of claim 1 wherein said data further includes:
images; and
vehicle telemetry.

3. The method of claim 2 wherein said relocalizing further includes:
measuring movement of said vehicle; and
adjusting said trajectory according to said movement.

4. The method of claim 3 wherein said measuring further includes:
using an inertial measurement unit.

5. The method of claim 3 wherein said measuring further includes:
using a GNSS receiver.

6. The method of claim 3 wherein said receiving further includes:
obtaining lateral information from said driver; and
obtaining longitudinal information from said driver.

7. The method of claim 3 wherein said measuring further includes:
using wheel odometry.

8. The method of claim 3 wherein said measuring further includes:
Using camera odometry.

9. A system for remotely operating a vehicle by a driver comprising:
data gathered by sensors coupled to a vehicle;
sender for transmitting said data to a driver station;
controls coupled to said driver station receiving a navigation;
computer to compute a trajectory using said navigation and data;
transmitter for transmitting said trajectory to said vehicle;
relocalizer coupled to said vehicle to adjust said trajectory; and
instructor directing said vehicle to follow said adjusted trajectory.

10. The system of claim 9 wherein said data further includes:
images; and
vehicle telemetry.

11. The system of claim 10 wherein said relocalizer further includes:
Measurer to measure movement of said vehicle; and
Adjusting said trajectory according to said movement.

12. The system of claim 11 wherein said measurer further includes:
an inertial measurement unit.

13. The system of claim 11 wherein said measurer further includes:
a GNSS receiver.

14. The system of claim 11 wherein said controls further include:
one or more lateral sensors; and
one or more longitudinal sensors.

15. The system of claim 11 wherein said measurer further includes:
a wheel odometry sensor.

16. The system of claim 11 wherein said measurer further includes:
A camera odometry sensor.
